(19) United States
(12) Patent Application Publication
(10) Pub. No.: US 2002/0151447 A1
(43) Pub. Date: Oct. 17, 2002

(54) Reduced toxicity 1-bromopropane cleaning agent production process

(75) Inventor: Richard G. Henry, Beachwood, OH (US)

Correspondence Address: Brian G. Bembenick, FAY, SHARPE, FAGAN, MINNICH & McKEE, LLP, Seventh Floor, 1100 Superior Avenue, Cleveland, OH, 44114, US

(73) Assignee: POLYMER SOLVENTS, INC., Beachwood, OH (US)

(21) Appl. No.: 10/123,680

(22) Filed: Apr. 16, 2002

Related U.S. Application Data
(62) Division of application No. 09/661,274, filed on Sep. 13, 2000.
Application No. 09/661,274 is a continuation-in-part of application No. 09/546,490, filed on Apr. 10, 2000.
Application No. 09/546,490 is a division of application No. 09/022,779, filed on Feb. 12, 1998, now Pat. No. 6,048,471.
(60) Provisional application No. 60/053,073, filed on Jul. 18, 1997.

(51) Int. Cl. B08B 5/00; C11D 1/00

(52) U.S. Cl. 510/175; 134/31

(57) ABSTRACT

A method for the production of a cleaning agent and a solvent carrier with reduced toxicity resulting from lower isopropyl bromide (2-bromopropane) content will be described. The cleaning agents are effective for removal of various soils but have a lower tendency to create health problems upon inhalation.

### CROSS NOTING TO RELATED APPLICATIONS

This application is a continuation-in-part of U.S. application Ser. No. 09/546,490, filed Apr. 10, 2000 which is a divisional of U.S. application Ser. No. 09/022,779, filed Feb. 12, 1998, now U.S. Pat. No. 6,048,471, which claims priority to Provisional Application Serial No. 60/053,073 filed Jul. 18, 1997.

### FIELD OF THE INVENTION

This invention pertains to the field of solvents. In particular, this invention pertains to the production and use of 1-brompropane as a reduced toxicity cleaning agent.

### BACKGROUND OF THE INVENTION

Solvent cleaning of articles containing fluxes, greases and various soils has been an industrial and commercial standard for many years. However, solvents have several problems which have concerned environmentalists and toxicologists. Many non-flammable solvents have been classified as ozone depleting compounds because they contain chlorine or bromine atoms and have been banned under the Montreal Protocol. Other solvents, such as hydrocarbon-based solvents, have fallen out of favor because they have been classified by the United States Environmental Protection Agency (U.S.E.P.A) and other international regulatory agencies as materials that contribute to the formation of ground based ozone and smog. Still other solvents have been banned due to high inherent toxicity upon inhalation by the user. These toxic effects can be headaches, nausea, dizziness, liver disease or worse.

One of the newest solvents to be considered as a candidate to replace some of the banned ozone depleting type compounds is 1-bromopropane (n-propyl bromide or nPB). 1-bromopropane has a very low ozone depletion potential of only 0.014 and a very short atmospheric lifetime of about 11 days. 1-bromopropane also has relatively low toxicity to mammals. A workplace exposure limit for handlers of 1-bromopropane has been established by independent testing to be 100 ppm for an 8 hour workday.

A negative consequence of the manufacturing process currently used in production of 1-bromopropane has been the production of an isomer of 1-bromopropane which is 2-bromopropane (isopropyl bromide). 2-bromopropane has been linked to birth defects and is known as genotoxic.

U.S. Pat. No. 6,049,014 describes the production of n-propyl bromide by a non-aqueous propyl alcohol and tetrabromobisphenol process. This process produces n-propyl bromide which contains an unacceptable and unsafe level of isopropyl bromide (2-bromopropane). The n-propyl bromide produced from this process may be suitable as a pharmaceutical intermediate however the process for producing the n-propyl bromide is not as safe as the process shown according to this application which minimizes isopropyl bromide.

Other methods for producing n-propyl bromide are known. For example, U.S. Pat. No. 5,773,672 discloses a process for producing n-propyl bromide which does not use n-propyl alcohol. JP8337795A2, JP10046197A2, JP11246898A2, JP7150197A2, JP6220494A2, JP09302389A2, U.S. Pat. Nos. 5,824,162, 5,707,954, 5,690,862, 5,679,632, 5,669,985, 5,665,173, 5,616,549, 5,938,859, 5,990,071, 5,858,953 and 5,792,277 all disclose cleaning processes utilizing n-propyl bromide. However, no mention is made of 2-bromopropane content or the toxicity to the user in these patents.

Accordingly, the present invention provides a process which produces a cleaning agent comprising 1-bromopropane that is safer than any of the prior art processes known. The production of this safer and less toxic 1-bromopropane based cleaning agent is accomplished by the use of a propyl alcohol feedstock which contains less than 0.1% by weight of isopropyl alcohol. It has been discovered that careful selection of propyl alcohol feedstock having less than 0.1% by weight of isopropyl alcohol will minimize the unwanted side reaction which produces the isopropyl bromide (2-bromopropane).

As such, it is the object of this invention to produce a 1-bromopropane based cleaning agent which contains less than 0.1% by weight of 2-bromopropane so as not to create a serious health hazard to the user of a 1-bromopropane based cleaning agent.

### SUMMARY OF THE INVENTION

In accordance with the present invention a novel process is described for producing n-propyl bromide with sufficiently low isopropyl bromide content so as to be useful in meeting the occupational exposure limits required by the United States Environmental Protection Agency. The process of the invention produces n-propyl bromide which can be used to produce a low toxicity cleaning agent or solvent carrier.

An object of this invention is directed to a novel high performance processes which produces n-propyl bromide that is of very high purity and mostly free of the unwanted isopropyl bromide which has been shown to be genotoxic.

Another object of this invention is to produce a low toxicity cleaning agent utilizing the high purity, 1-bromopropane produced from the novel process.

A further object of this invention is to demonstrate how this high purity, low toxicity, 1-bromopropane can be used as a solvent carrier for resins and polymers in the production of adhesives, coatings, inks and the like.

Still other objects, advantages and benefits of the invention will become apparent to those skilled in the art upon a reading and understanding of the following detailed description.

### DESCRIPTION OF THE PREFERRED EMBODIMENTS

In practicing the invention, any type of bromination reaction utilizing as a starting material, n-propyl alcohol, can be used. Typically HBr, elemental bromine or hydrobromic acid is used to brominate the n-propyl alcohol. This bromination is then followed by distillation. In this process, careful attention will be made as to the content of unwanted alcohols, in particular isopropyl alcohol, present in the n-propyl alcohol feedstock. Gas chromatographic analysis can be used, for example, to determine the concentration of isopropyl alcohol or sec-butanol present in said feedstock. Fractional distillation of technical grade propyl alcohol will reduce the IPA (isopropyl alcohol) content. In a preferred embodiment, a final concentration of 0.1% or less of isopropyl bromide is desired.

The following table lists various sources of n-propyl alcohol which can be used as the starting material in the reaction according to the present invention (identified by yes in column five of the table). The n-propyl alcohol feedstock materials have less than or equal to 0.1 wt. % isopropyl alcohol.

TABLE 1

| | | | | | | Useful as |
|---|---|---|---|---|---|---|
| Manufacturer of | IPA | | Bromination | IPA | | a cleaning |
| n-propyl | content | | reaction to | content | | agent |
| Eastman | 1% | | — | 0.9% | | No |
| Eastman | 500 | ppm | — | 450 | ppm | Yes |
| TR-Metro | 2% | | — | 1.6% | | No |
| Ashland | 2% | | — | 1.6% | | No |
| SASOL n- | 10 | ppm | — | <10 | ppm | Yes |
| Mallinkrodt | 50 | ppm | — | 40 | ppm | Yes |
| Union Carbide | 900 | ppm | — | 780 | ppm | Yes |

The following examples demonstrate the production of the lower toxicity n-propyl bromide according to the present invention.

### EXAMPLE 1

N-propyl alcohol having 1% by weight isopropyl alcohol (determined by GC analysis) was obtained. The n-propyl alcohol was fractionally distilled so as to separate the isopropyl alcohol from the n-propyl alcohol. After distillation, GC analysis showed that the isopropyl alcohol content was reduced to 100 ppm or 0.01% by weight. The distilled n-propyl alcohol was then brominated using the method of mixing an alcohol with bromine, and refluxing the mix at a temperature of about 79° C. for about three hours and separating the reaction products by distillation thereby producing 1-bromopropane. The 1-bromopropane produced was analyzed by GC and was found to contain 80 ppm of isopropyl bromide.

### EXAMPLE 2

5 gallons of the 1-bromopropane from Example 1 was stabilized with 5% by volume of a stabilizer package which contained 68 grams of 1,3 dioxolane, 12 grams of 1,2 butylene oxide and 12 grams of nitromethane. This stabilizer package inhibits the decomposition of the 1-bromopropane and prevents attack upon metals. Stabilizers which may be used include, but are not limited to, epoxides, acetals and nitroparrafins. More or less of the stabilizer can be used depending upon the severity of the application. The mixture was added to the boiling sump of a vapor degreaser. The temperature of the boiling sump is maintained at about 159 to 161° F. so that the 1-bromopropane is vaporized. Circuit boards with rosin fluxes and various greases were immersed into the vapors. The fluxes and greases were dissolved by the hot 1-bromopropane vapors and were removed from the circuit boards. A measurement of the surrounding air was made using a Draeger tube and subsequent GC analysis. The GC analysis showed that the air surrounding the vapor degreaser contained less than 5 ppm of isopropyl bromide therefore indicating a high degree of safety for the degreaser operator and falling within the permissible guidelines established by the E.P.A.

### EXAMPLE 3

100 ml of the 1-bromopropane prepared in accordance with Example 1 was mixed with 30 grams of various resins and polymers including styrene-butadiene, polychloroprene, natural rubber, urethane, PVC, and acrylic. Ten (10) grams of a hydrocarbon tackifier (i.e. an olefin or methacrylate) can then be added. In each case an adhesive with excellent bond strength was found. Approximately one (1) minute after the 1-bromopropane evaporated, a measurement of the surrounding air was made using the technique of Example 2. The air was found to contain less than 5 ppm of isopropyl bromide indicating a high degree of safety for the user and falling within the permissible guidelines established by the E.P.A.

Various compositions comprising 1-bromopropane, having reduced toxicity to the user, can be formulated utilizing the 1-bromopropane produced in accordance with the present invention. U.S. patent application Ser. No. 6,048,471, incorporated herein by reference, describes various 1-bromopropane containing compositions for which the 1-bromopropane prepared in accordance with the present invention is particularly suitable for.

The invention has been described with reference to the preferred embodiments. Obviously, modifications and alterations will occur to others upon a reading and understanding of this specification. It is intended to include all such modifications and alterations insofar as they come within the scope of the appended claims or the equivalents thereof.

1. An improved process for the production of a reduced toxicity cleaning agent comprising 1-bromopropane and containing 0.1% or less of 2-bromopropane wherein said process comprises the step of bromination of n-propyl alcohol, further wherein the improvement comprises providing an n-propyl alcohol feedstock which contains less than 0.1% by weight of isopropyl alcohol.

2. An improved process for the production of a reduced toxicity cleaning agent comprising 1-bromopropane and containing 0.05% or less of 2-bromopropane wherein said process comprises the step of bromination of a n-propyl alcohol further wherein the improvement comprises providing an n-propyl alcohol feedstock which contains less than 0.05% by weight of isopropyl alcohol.

3. An improved process for the production of a reduced toxicity cleaning agent comprising 1-bromopropane and containing 0.01% or less of 2-bromopropane wherein said process comprises the step of bromination of n-propyl alcohol further wherein the improvement comprises providing an n-propyl alcohol feedstock which contains less than 0.01% by weight of isopropyl alcohol.

4. An improved process for the production of a reduced toxicity cleaning agent comprising 1-bromopropane and containing 0.01% or less of 2-bromopropane wherein said process comprises the steps of distilling n-propyl alcohol to a purity of 99.99% n-propyl alcohol, recovery of the n-propyl alcohol from the distillation, and bromination of the n-propyl alcohol recovered from the distillation.

5. A reduced toxicity cleaning agent composition comprising 1-bromopropane produced by the process according to claim 1.

6. The composition of claim 5 further comprising 0.1% to 10% by weight a stabilizer package which prevents decomposition and reactivity of the 1-bromopropane.

7. A reduced toxicity solvent carrier used in production of adhesives, coatings and inks comprising 1-bromopropane produced by the process according to claim 1.

8. The composition of claim 7 further comprising 0.1% to 10% by weight of a stabilizer package which prevents decomposition and reactivity of the 1-bromopropane.

9. The composition of claim 6 wherein the stabilizer package comprises one or more of a compound selected from the group consisting of epoxides, acetals and nitroparaffins.

10. The composition of claim 8 wherein the stabilizer package comprises one or more of a compound selected from the group consisting of epoxides, acetals and nitroparaffins.

11. A method for cleaning circuit boards comprising heating the composition of 1-bromopropane according to claim 6 to its vaporization point and exposure of said circuit boards to vapors emanating from the composition of claim 6 wherein the vapors eminating from the heated 1-bromopropane contain less than 100 ppm of 2-bromopropane.

12. The method according to claim 11 wherein the vapors emanating from the heated 1-bromopropane contain less than 5 ppm of 2-bromopropane.
